(19) United States
(12) Patent Application Publication
(10) Pub. No.: US 2015/0046726 A1
(43) Pub. Date: Feb. 12, 2015

(54) ELECTRONIC APPARATUS

(71) Applicant: Kabushiki Kaisha Toshiba, Tokyo (JP)

(72) Inventors: Yoshiya YOKOYAMA, Tokyo (JP); Tooru MAMATA, Tokyo (JP)

(21) Appl. No.: 14/456,818

(22) Filed: Aug. 11, 2014

Related U.S. Application Data
(60) Provisional application No. 61/864,812, filed on Aug. 12, 2013.

(51) Int. Cl. G06F 1/26; G06F 1/32

(52) U.S. Cl. CPC G06F 1/266; G06F 1/3287
USPC 713/300

(57) ABSTRACT

There is provided a method of preventing an erroneous operation of a Wake-up device connected to a general-purpose USB port in an electronic apparatus. The method including the step of determining whether or not the Wake-up device is connected, the step detecting whether or not the electronic apparatus is moving, and the step of preventing Wake-up of the Wake-up device.

### CROSS-REFERENCE TO RELATED APPLICATION(S)

This application claims priority from U.S. Provisional Patent Application No. 61/864,812 filed on Aug. 12, 2013, the entire contents of which are incorporated herein by reference.

### TECHNICAL FIELD

An embodiment of the present invention relates to an electronic apparatus.

### BACKGROUND ART

Recently, various electronic apparatuses such as a notebook type personal computer (PC) and a tablet have been developed. Many of such electronic apparatuses include a port to which a portable device can be attached, for example, a USB (Universal Serial Bus) port. The USB port not only enables a communication between the electronic apparatus and the portable device to be performed, but also can be used for charging or supplying electric power to the portable device, or for performing a Wake-up control.

As a background, a PC has a function (USB Wake-up) of, when a USB device such as a USB mouse is operated during a period when the system is turned OFF, activating the system. In the case where a PC is moved together with a USB device which is set to Wake-up, however, the system is sometimes waked up by an operation which is performed on the USB device, but which is not intended by the user.

In order to comply with this problem, conventionally, an improvement has been proposed in which Wake-up of a specific USB device in a system is inhibited. However, this method has a problem in that the improvement cannot be applied to a USB device which is connected to an external general-purpose USB port. In the method, namely, only a Wake-up operation performed by a specific USB device in a system is inhibited. Therefore, the method cannot be applied to a USB device which is connected to a general-purpose USB port for external connection.

While it is requested to suppress a Wake-up operation performed by an external unspecific USB device which is connected to a general-purpose USB port, means for satisfying the request is not known.

### BRIEF DESCRIPTION OF THE DRAWINGS

FIG. 1 is a perspective view showing the appearance of an electronic apparatus of an embodiment.

FIG. 2 is a block diagram showing the system configuration of the electronic apparatus of the embodiment.

FIG. 3 is a schematic functional block diagram showing devices (system) of main portions in the embodiment.

FIGS. 4A and 4B are views illustrating an IIC interface used in the embodiment.

FIG. 5 is a chart showing a command sequence which is used in the embodiment, and which is in the case where the power supply is OFF.

FIG. 6 is a process flow chart of main portions in the embodiment.

FIG. 7 is a schematic functional block diagram showing devices (system) of main portions used in another embodiment.

### MODE FOR CARRYING OUT THE INVENTION

Hereinafter, embodiments of the invention will be described.

### First Embodiment

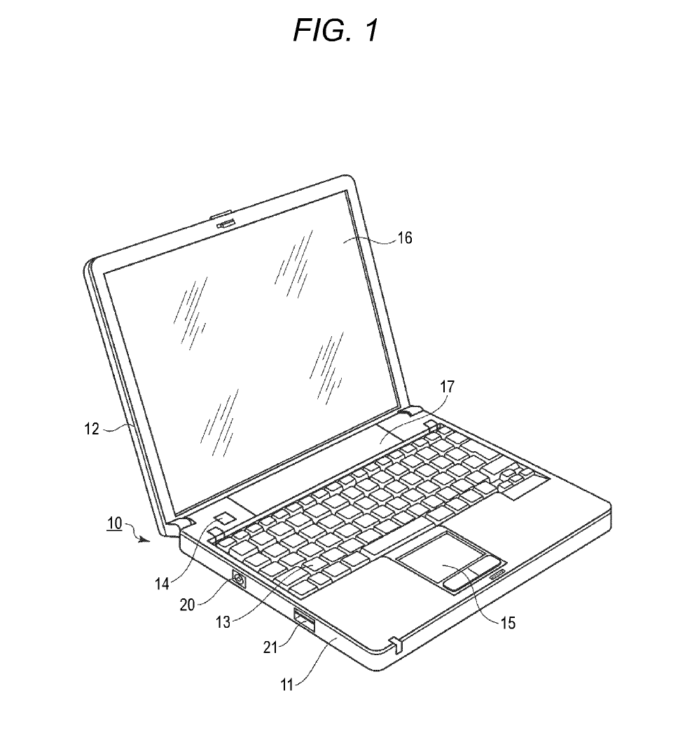

A first embodiment will be described with reference to FIGS. 1 to 6.

First, referring to FIG. 1, the configuration of an electronic apparatus of an embodiment will be described. The electronic apparatus is configured to be powered by a battery. The electronic apparatus may be realized as, for example, a notebook type portable personal computer, a tablet terminal, or other various information processing apparatuses. Hereinafter, it is assumed that the electronic apparatus is realized as a notebook type portable personal computer 10.

FIG. 1 is a perspective view of the computer 10 in a state where a display unit is opened, as viewed from the front side. The computer 10 is configured to be powered by a battery 17. The battery may be configured by a usual lithium-ion battery or the like which is designed to have a high capacity.

In the computer 10, the electric power discharged by the battery 17 is used for supplying power to components of the computer 10. The power output terminal of the battery 17 may be wired-OR connected to a power output terminal of an external power supply device such as an AC adapter. In this case, the output voltage of the battery 17 may be set so that the output voltage of the external power supply is higher than that of the battery 17. According to the configuration, the power of the external power supply can be used more preferentially than that of the battery 17, to supply power to the components of the computer 10.

In the case where the battery 17 is not in the fully charged state, a charging circuit in the computer 10 charges the battery 17 by using the power of the external power supply device.

The computer 10 is configured by the computer body 11 and the display unit 12. A display device configured by an LCD 16 (Liquid Crystal Display) is incorporated in the display unit 12.

The display unit 12 is attached to the computer body 11 so as to be swingable between an opened position where the upper surface of the computer body 11 is exposed, and a closed position where the upper surface of the computer body 11 is covered by the display unit 12. The computer body 11 has a thin box-like housing. A keyboard 13, a power supply switch 14 for powering ON/OFF the computer 10, and a touch pad 15 are placed on the upper surface of the computer body.

A power supply connector 20 is disposed in the computer body 11. The power supply connector 20 is disposed on a side surface of the computer body 11, such as the left side surface. An external power supply device is detachably connected to the power supply connector 20. As described above, an AC adapter may be used as the external power supply device. An AC adapter is a power supply device which converts a commercial power supply (AC power) to DC power.

The power supply connector 20 is configured by a jack to which a power supply plug derived from an external power supply device such as an AC adapter can be detachably connected. The battery 17 is detachably mounted in, for example, a rear end portion of the computer body 11. Alternatively, the battery 17 may be a battery which is incorporated in the computer 10.

The computer 10 is driven by the power supplied from the external power supply device, or that supplied from the battery 17. When the external power supply device is connected to the power supply connector 20 of the computer 10, the computer 10 is driven by the power supplied from the external power supply device. When the power which is consumed by the computer 10 is largely increased for any reason, there sometimes arises a case where the amount of power required by the computer 10 exceeds that supplied from the external power supply device. In this case, not only the power supplied from the external power supply device, but also the power supplied from the battery 17 is used. One of operations which may cause the power consumed by the computer 10 to be increased is to charge a portable device attached to the computer 10.

As described above, the power supplied from the external power supply device is used also for charging the battery 17. The battery 17 may be charged not only while the computer 10 is powered ON, but also while the computer 10 is powered OFF. During the period when the external power supply device is not connected to the power supply connector 20 of the computer 10, the computer 10 is driven by the power supplied from the battery 17.

A port (connector) 21 such as a USB port is disposed in the computer body 11. The port 21 is a port which is used for detachably attaching a portable device to the computer body 11. The port 21 is used for performing a communication between the computer 10 and the portable device. The port 21 may be used for charging or supplying electric power to the portable device. In the following description, it is assumed that the port 21 is a universal serial bus (USB) port.

In a USB port, generally, a pair of power supply lines (V_{BUS}, ground (GND)), a positive data line (D+), and a negative data line (D−) are defined. The V_{BU}S is a positive power supply line. The computer 10 can supply electric power (bus power) to a portable device attached to the USB port 21, through the V_{BUS} and the ground (GND).

The positive data line (D+) and the negative data line (D−) function as a differential signal line pair. The computer 10 can communicate with a portable device attached to the USB port 21, through the positive data line (D+) and the negative data line (D−).

The computer 10 has a charger function which can charge a battery of a portable device. The charger function has two charge modes, i.e., a normal mode and a large-current charge mode. The normal mode is a charge mode in which, for example, a maximum current of 0.5 A (first charge current) can be supplied to a portable device. The large-current charge mode is a charge mode in which a current that is larger than that in the normal mode, for example, a maximum current of 1.5 A (second charge current) can be supplied to a portable device. During a period when the computer 10 is powered ON, the charger function can charge a battery of a portable device while using an arbitral one of the two charge modes, or the normal mode and the large-current charge mode. In other words, during a period when the computer 10 is powered ON, the USB port 21 can function as any one of a first type port through which the first charge current can be supplied, and a second type port through which the second charge current that is larger than the first charge current can be supplied.

For example, the first type port may be a port corresponding to the standard down-stream port (SDP) which is specified in Battery Charging Specification Revision 1.1. The second type port may be a port corresponding to the charging down-stream port (CDP) which is specified in Battery Charging Specification Revision 1.1.

The use of the second type port (large-current charge mode) enables a battery of a portable device to be rapidly charged.

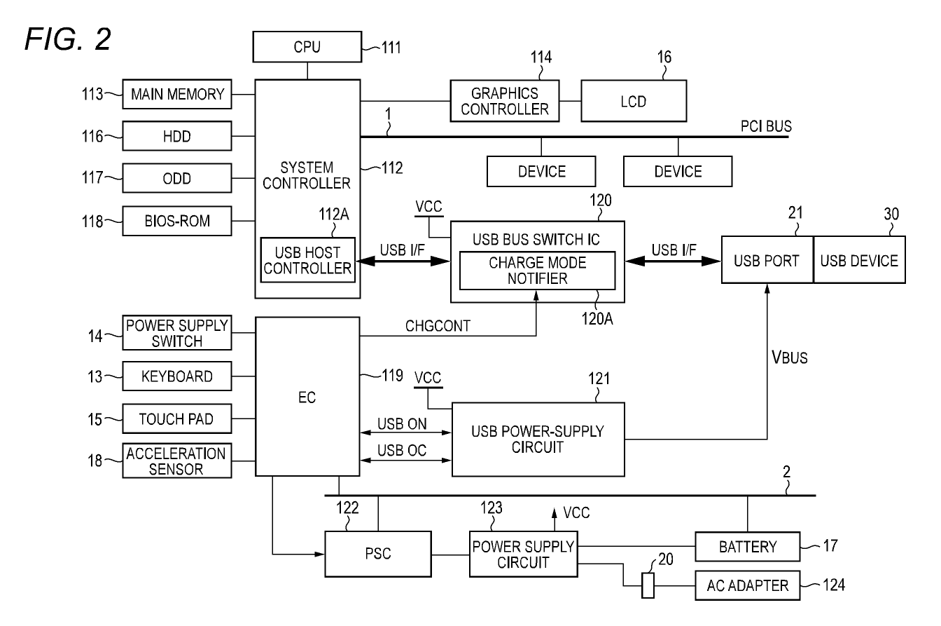

FIG. 2 shows the system configuration of the computer 10. The computer 10 includes a CPU 111, a system controller 112, a main memory 113, a graphics controller 114, a hard disk drive (HDD) 116, an optical disk drive (ODD) 117, a BIOS-ROM 118, an embedded controller (EC) 119, a USB bus switch IC 120, a USB power-supply circuit 121, a power-supply controller (PSC) 122, a power supply circuit 123, and the like.

The CPU 111 is a processor which controls operations of various components of the computer 10. The CPU 111 executes various softwares which are loaded from the HDD 116 into the main memory 113, such as an operating system (OS) and various application programs. The CPU 111 executes also a Basic Input Output System (BIOS 118a) stored in the BIOS-ROM 118 which is a nonvolatile memory. The BIOS 118a is a system program for hardware control.

The system controller 112 is a bridge device which connects the CPU 111 with various components. The system controller 112 has a function of executing a communication with the graphics controller 114. The system controller 112 incorporates a memory controller which controls the main memory 113. The graphics controller 114 is a display controller which controls the LCD 16 used as a display monitor of the computer 10.

The system controller 112 is connected to a PCI bus 1, and executes a communication with devices on the PCI bus 1. The system controller 112 incorporates an IDE (Integrated Drive Electronics) controller and Serial ATA controller for controlling the hard disk drive (HDD) 116 and the optical disk drive (ODD) 117.

The system controller 112 further includes a USB host controller 112A. The USB host controller 112A is a host controller configured to control a USB device 30 which is a portable device that is detachably attached to the USB port 21, and executes a communication with the USB device 30. The communication between the USB host controller 112A and the USB device 30 is executed through a USB interface (USB I/F). The USB interface is configured by the positive data line (D+) and negative data line (D−) which are described above.

In the embodiment, the USB host controller 112A is connected to the USB port 21 through the USB bus switch IC 120. The USB bus switch IC 120 includes a charge mode notifier 120A in order to instruct the USB device 30 on a charge mode (USB charge mode) supported by the computer 10.

The charge mode notifier 120A executes an operation of notifying the USB device 30 whether the current USB charge mode of the computer 10 is the normal mode or the large-current charge mode, i.e., whether the USB port 21 functions as the first type port (for example, the standard down-stream port (SDP)) or functions as the second type port (for example, the charging down-stream port (CDP)), through a communication with the USB device 30 through the USB port 21.

For example, the USB device 30 can execute a process (charger detection process) of detecting the type of the USB port 21 in accordance with a protocol specified in Battery Charging Specification Revision 1.1. The charge mode notifier 120A has a function of responding to the charger detection process which is executed by the USB device 30.

The charger detection process is started by the USB device 30 in order to determine the type of the USB port 21 of the computer 10 (host device). Namely, the USB device 30 attached to the USB port 21 applies a predetermined voltage to the positive data line (D+), and checks the voltage on the negative data line (D−), thereby determining the type of the USB port 21.

In accordance with a charge mode setting signal (CHGCONT) supplied from the EC 119, the charge mode notifier 120A executes one of a response process of notifying that the USB port 21 functions as the first type port, and a response process of notifying that the USB port 21 functions as the second type port.

The USB power-supply circuit 121 operates as a first power-supply circuit which is configured to supply bus power (V_{BUS}) to the USB device 30 through the USB port 21. The USB power-supply circuit 121 is designed to have a power supply capability which enables large current charging such as that in the charging down-stream port (CDP) to be executed. The USB power-supply circuit 121 is turned ON or OFF in accordance with a USB ON signal supplied from the EC 119.

The USB power-supply circuit 121 further has an over-current detection function, and detects whether a current pulled by the USB device 30 through the USB port 21 exceeds an upper limit value or not. When the USB power-supply circuit 121 detects that the current pulled by the USB device 30 exceeds the upper limit value, the circuit generates a USB over-current detection signal USB OC to notify the EC 119 that an overcurrent is detected. In this case, the EC 119 may turn OFF the USB power-supply circuit 121.

The EC 119, the power-supply controller (PSC) 122, and the battery 17 are connected to one another through a serial bus 2 such as an I2C bus. The embedded controller (EC) 119 is a power supply management controller for executing power management on the computer 10, and realized as, for example, a one-chip microcomputer incorporating a keyboard controller for controlling the keyboard (KB) 13, the touch pad 15, and the like. The EC 119 has a function of powering ON/OFF the computer 10 in accordance with an operation of the power switch 14 which is carried out by the user. The control of powering ON/OFF the computer 10 is executed by a cooperative operation of the EC 119 and the power-supply controller (PSC) 122. Upon receipt of an ON signal transmitted from the EC 119, the power-supply controller (PSC) 122 controls the power supply circuit 123 to power ON the computer 10. Upon receipt of an OFF signal transmitted from the EC 119, the power-supply controller (PSC) 122 controls the power supply circuit 123 to power OFF the computer 10. Also during a period when the computer 10 is powered OFF, the EC 119, the power-supply controller (PSC) 122, and the power supply circuit 123 are operated by the power from the battery 17 or the AC adapter 124.

The EC 119 monitors the residual capacity of the battery 17. In the case where the remaining capacity of the battery 17 is smaller than a threshold, the EC controls the operation of the USB bus switch IC 120 (charge mode notifier 120A) so that the USB port 21 is recognized as the first type port by the USB device 30. For example, the EC 119 can receive battery information indicative of the remaining capacity of the battery 17 from the power-supply controller (PSC) 122. It is a matter of course that the EC 119 may directly receive the battery information indicative of the remaining capacity of the battery 17 from the battery 17. The EC 119 executes also the control of the USB power-supply circuit 121.

An acceleration sensor 18 is disposed in the computer body 11. For example, the acceleration sensor 18 is disposed in the interior of the computer body 11. In addition to the above-described configuration, for example, the acceleration sensor 18 is connected to the EC 119.

The acceleration sensor 18 is an acceleration sensor of three-axis directions (X, Y, and Z directions) or six-axis directions in which detections of rotations about the axes are added to the axis directions, or the like, detects the direction and magnitude of acceleration which is applied from the outside to the computer body 11, and outputs them to the CPU 111 through the EC 119. Specifically, the acceleration sensor 18 outputs an acceleration detection signal (tilt information) including: the axis in which an acceleration is detected; the direction (in the case of rotation, the rotation angle); and the magnitude, to the CPU 111 through the EC 119. A mode in which a gyro sensor for detecting an angular velocity (rotation angle) is integrated with the acceleration sensor 18 may be employed.

The embedded controller (EC) 119, the USB bus switch IC 120, and the USB power-supply circuit 121 function as a charge control device which is configured to control the charging of the USB device 30 attached to the USB port 21.

The charge control device can charge the USB device 30 also during a period when the computer 10 is powered OFF. In this case, the charging of the USB device 30 may be executed by, for example, using the above-described normal mode.

While using the power supplied from the battery 17, or that supplied from the AC adapter 124 which is connected as an external power supply to the computer body 11, the power supply circuit 123 produces electric power (operation power supply) to be supplied to the components. In the case where the AC adapter 124 is connected to the computer body 11, while using the power from the AC adapter 124, the power supply circuit 123 produces the operation power supply to be supplied to the components, and charges the battery 17.

The embodiment relates to a function (USB Wake-up) of activating the system when a USB device is operated during the system OFF state of the PC. That is, the embodiment realizes a function of inhibiting such USB Wake-up in a situation where the user carries the PC.

To solve the problem, according to the improvement of the embodiment, there is provided “a system in which, when the system is to be OFF, it is checked whether a USB Wake-up device is connected to the external general-purpose USB port or not, and, when it is detected that, in the connected state, the user moves (carries) the system during a period when the system is OFF, Wake-up performed by the USB Wake-up device is inhibited.”

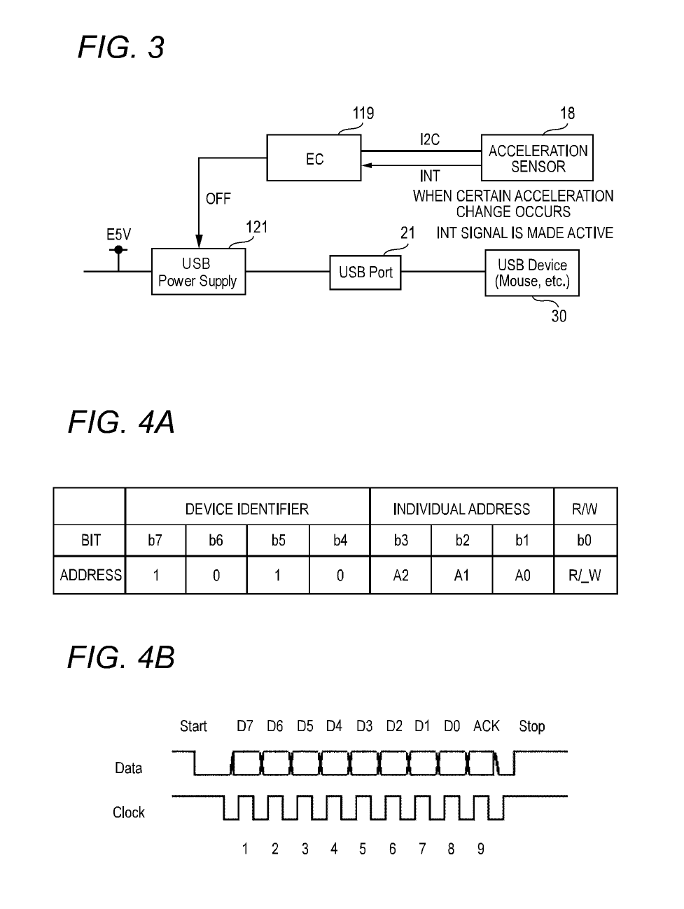

FIG. 3 is a schematic functional block diagram showing devices (system) of main portions in the embodiment. As shown in the block diagram, the system configuration includes the EC 119, the acceleration sensor 18, the USB port 21, the USB power-supply circuit 121, and the USB device 30.

FIGS. 4A and 4B are views illustrating the above-described IIC (I2C, I²C) interface. A bus (IIC-BUS) of the IIC interface is configured by two communication lines of a pull up clock which is output from a master device, and data which performs a bidirectional communication between the master device and a slave device.

FIG. 4A shows a configuration example of a slave address. A slave address has an 8-bit length, and the upper 4 bits are fixedly determined in accordance with the kind of a device. The lower 1 bit indicates writing when the bit is 0, and reading when the bit is 1. Therefore, actually useful bits in the slave address are bits 1 to 3.

FIG. 4B is a timing diagram of the two lines. As in the upper side, when the signal level of the data line becomes LOW, Start is set, and data are sequentially transmitted from the most significant bit. When the signal level of the data line becomes HIGH, the Stop state is set. The timing of the corresponding clock line is shown in the lower side. FIG. 4B shows an example of the one-byte transfer. When data and ACK are repeated plural times until the Stop state, the first byte is the slave address, but the remaining bytes can contain communication contents.

Returning to FIG. 3, the EC 119 is configured as a master device, and by contrast the acceleration sensor 18 is configured as a slave device. The acceleration sensor 18 is configured to, when a certain acceleration change occurs, for example, an INT (interruption) signal is made active, and then sent to the EC 119, and the EC 119 turns OFF the USB power-supply circuit 121 at this time.

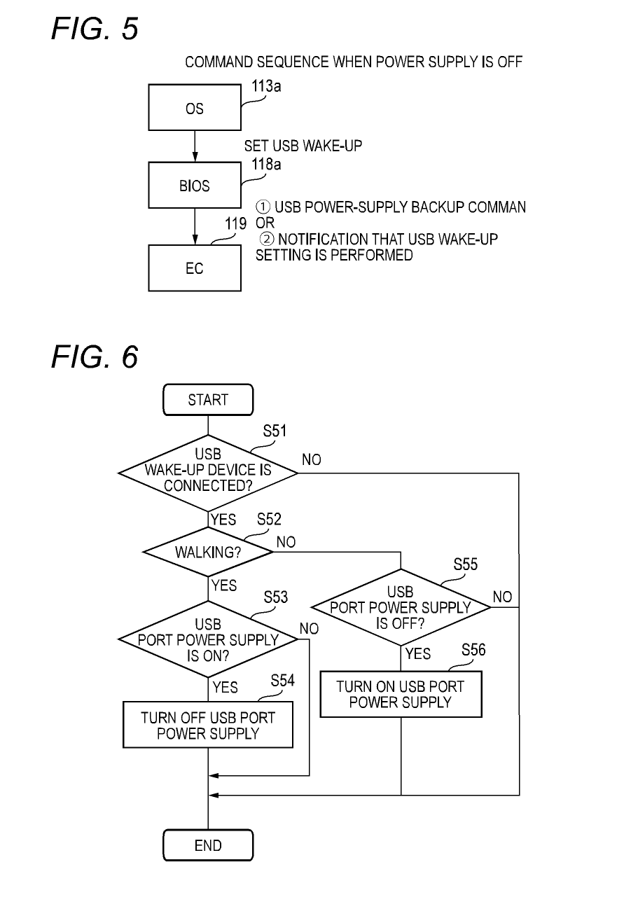

FIG. 5 is a chart showing a command sequence which is used in the embodiment, and which is in the case where the power supply is OFF. As shown in FIG. 5, an OS 113a launched in the main memory 113 performs a USB Wake-up setting on the BIOS 118a. When receiving a USB power-supply backup command from the BIOS 118a, or when receiving a notification command indicating that a USB Wake-up setting is performed, the EC 119 determines that a USB Wake-up device is connected to the external port. Namely, these constitute a system which uses a USB power-supply backup request that is sent through a path of the OS 113a, the BIOS 118a, and the EC 119, as a unit for checking connection of a USB Wake-up device.

The EC 119 sets a function of acquiring acceleration data by the acceleration sensor 18 during the system OFF period, to be effective, and, in the case where conditions (1) or (2) below are satisfied (when the above-described INT signal arrives), determines that the user carries the PC.

(1) An acceleration change (for example, 0.5 G or more where G is the acceleration of gravity) is continued for a certain time period (for example, one minute).

(2) A walking state is detected from the acceleration change pattern (since a peak of the acceleration change appears when the user swings down the foot in the walking movement, the user's walking state may be detected upon observation of such a peak at certain intervals (about 30 to 100 times per minute)).

As to above (2), for example, a so-called pedometer employs a technique in which steps are not counted up in the case of being shaken by the hand, but steps are counted up in the case of being regularly attached in response to the user's walking.

In the case where it is determined that the user carries the PC, and a USB Wake-up device is connected to an external port, the EC 119 turns OFF (interrupts) the power of all the USB ports, to inhibit the USB Wake-up.

FIG. 6 is a process flow chart of main portions in the embodiment.

Step S51: The EC 119 determines whether a USB Wake-up device is connected or not. If it is determined that a USB Wake-up device is connected, the process proceeds to the next step, and, if not, the process is terminated.

Step S52: The EC 119 determines, depending on the INT signal, whether the user is walking or not. If it is determined that the user is walking, the process proceeds to the next step, and, if not, the process proceeds to step S55.

Step S53: The EC 119 determines whether a USB port power supply is turned ON or not. If it is determined that the power supply is turned ON, the process proceeds to the next step, and, if not, the process is terminated.

Step S54: The EC 119 turns OFF the USB port power supply, and the process is terminated.

Step S55: The EC 119 determines whether the USB port power supply is turned OFF or not. If it is determined that the power supply is turned OFF, the process proceeds to the next step, and, if not, the process is terminated.

Step S56: The EC 119 turns ON the USB port power supply, and the process is terminated.

### Second Embodiment

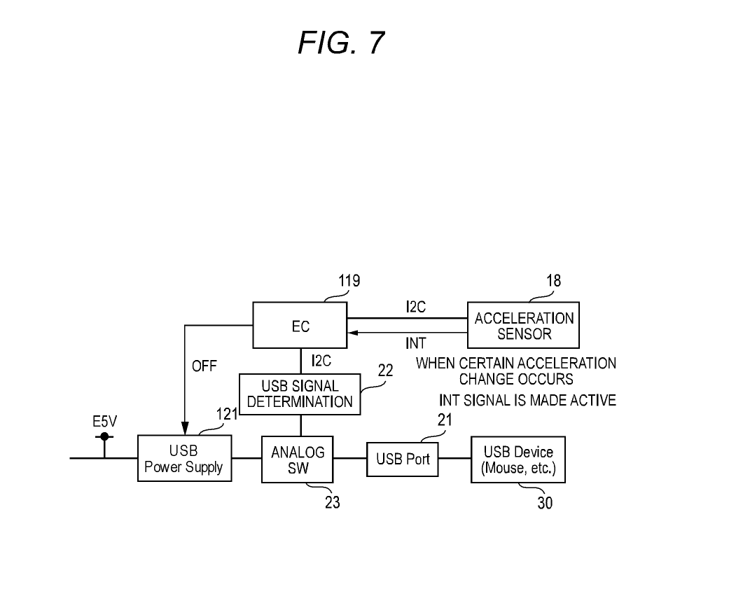

A second embodiment of the invention will be described with reference to FIG. 7. Description of components which are common to those of the first embodiment is omitted.

FIG. 7 is a schematic functional block diagram showing devices (system) of main portions used in the embodiment. In the block diagram of FIG. 7, in addition to the configuration of FIG. 3, the embodiment includes a USB signal determination IC 22 and an analog SW 23. According to the configuration, it is possible to acquire information of a port to which a USB Wake-up device (Low-speed device) is connected, and, in conjunction with information of a command received from the BIOS 118a described in the first embodiment, only the specific port to which the USB Wake-up device is connected can be powered OFF. It is possible to employ a configuration where plural sets of the USB signal determination IC 22, the analog SW 23, and the USB port 21 are prepared and connected to the EC 119 and the USB power-supply circuit 121.

For example, the signal determination by the USB signal determination IC 22 is performed in the following manner.

In the configuration, first, a USB is a bus, and therefore a terminal resistor is necessary. Unlike the SCSI system or the like, in the case of the USB, however, a terminal resistor is incorporated in a host side (IC chip) or an apparatus, and therefore the user is not requested to explicitly connect a terminal resistor. When nothing is connected to the USB host (USB port 21), both the D+/D− lines are pulled down by a resistor of 15 kΩ±5% incorporated in the host, and the signal level is “L”. The host (USB signal determination IC 22) monitors a change of the D+/D− lines in this state.

In the above-described embodiment, the followings are described as the function of inhibiting the USB Wake-up caused by the PC during the system OFF state.

(1) When, in advance of an event (movement), it is determined that a USB Wake-up device is connected to an external port, it is possible to inhibit Wake-up performed by an unspecified USB device connected to an external general-purpose USB port.

(2) The furnishing of the USB signal determination IC and the analog SW enables only a specific USB port to be powered OFF.

The invention is not limited to the above-described embodiments, and may be otherwise embodied while variously modified without departing the spirit of the invention.

By appropriate combinations of plural components disclosed in the above-described embodiments, various inventions may be configured. For example, some of the components may be omitted from all of the components shown in the embodiments. The components in different embodiments may be appropriately combined.

1. A method of preventing an erroneous operation of a Wake-up device connected to a general-purpose USB port in an electronic apparatus, the method comprising:
determining by the electronic apparatus whether the Wake-up device is connected;
detecting whether the electronic apparatus is moving; and
preventing Wake-up of the Wake-up device.

2. The method of claim 1,
wherein the determining is performed based on a USB power-supply backup command or a notification command indicative of a USB Wake-up being set.

3. The method of claim 1,
wherein the preventing Wake-up is performed by causing an EC to power OFF the general-purpose USB port.

4. The method of claim 1,
wherein the preventing Wake-up is performed by causing an EC to specify, among general-purpose USB ports, a target USB port to which the Wake-up device is connected to thereby power OFF the target USB port.

5. The method of claim 1,
wherein the detecting is performed based on a continuous detection of an acceleration change of the electronic apparatus for a certain time period, or on an observation of a specific acceleration change pattern at certain intervals.

6. A device configured to prevent an erroneous operation of a Wake-up device connected to a general-purpose USB port, the device comprising:
a determination controller configured to determine whether the Wake-up device is connected;
a detection unit configured to detect whether the device is moving; and
a control unit configured to prevents Wake-up of the Wake-up device.
